(19) United States
(12) Patent Application Publication
(10) Pub. No.: US 2008/0168953 A1
(43) Pub. Date: Jul. 17, 2008

(54) Device to be Attached to or to be Worn by an Animal for Indicating the Physiological Status of the Animal

(75) Inventors: Ralph Kurt, Eindhoven (NL); Sepas Setayesh, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/997,169

(22) PCT Filed: Jul. 20, 2006
(86) PCT No.: PCT/IB2006/052486

§ 371 Date: Jan. 29, 2008

(30) Foreign Application Priority Data
Aug. 1, 2005 (EP) 05107093.6

(51) Int. Cl. A01K 15/02

(52) U.S. Cl. 119/859

(57) ABSTRACT

This invention relates to a device (100) to be worn by or attached to an animal (102) for indicating the physiological status of the animal. At least one measuring device is used for measuring the physiological state of said animal. The resulting physiological data are regularly compared to at least one threshold value when evaluating the current physiological status of said animal. Based thereon, indication means indicates the current physiological status of said animal.

### FIELD OF THE INVENTION

The present invention relates to a device to be attached to or to be worn by an animal for indicating the physiological status of the animal. The present invention relates further to a method of indicating the physiological status of the animal. The present invention further relates to a user device adapted to operate a device to be attached to or to worn by an animal, said device being used for indicating the physiological status of the animal. The present invention further relates to a method of operating a device to be attached to or to be worn by an animal using a user device, wherein said device is adapted to indicate the physiological status of the animal.

### BACKGROUND OF THE INVENTION

If you meet a dog outside, and you are not familiar with this dog, you are never sure if you can trust that it will not attack you, even if the owner tries to convince you that the dog is very friendly and has never caused any danger before. However, this situation is annoying for both the passer-by and the owner of the dog.

In recent years several severe accidents involving dangerous house pets have been reported. In Germany for instance every year a few children are seriously wounded and even killed. This has driven some governments so far as to change the law for keeping the pets. The responses from various countries to prevent such accidents are different. In some countries licenses to own a pet must be approved by the government, whereas in other countries special animal races must wear a muzzle all the time while being outside. Even banning several species has been considered as an option in some countries. And still, the situation for providing sufficient security for a passer-by who walks past a dog or any other animal is not yet solved.

In U.S. Pat. No. 5,749,324 an apparatus is disclosed, which comprises a sound-processing means selectively responsive to a plurality of sounds, an actuator means coupled to the sound-processing means selectively responsive to a plurality of electrical inputs from the sound processing means and a stimulus generating means coupled to the actuator means. The stimulus provided to the animal may include a human voice command with respect to the behavior correlated with the sound produced by the animal.

The problem with this reference is that a passer-by passing by the animal and the owner of the animal can not estimate the current physiological condition of the animal. This might e.g. result in that the owner of the animal can not prevent a sudden attack of the animal on the passer-by. In order to prevent such attacks either the owner must be able to respond before the animal reacts in such way, and preferably warn the passer-by before it is too late, or a method must be realized whereby the animal is automatically rendered harmless.

### OBJECT AND SUMMARY OF THE INVENTION

It is an object of the present invention to solve the before mentioned problem.

According to one aspect, the present invention relates to a device to be attached to or to be worn by an animal for indicating the physiological status of the animal, comprising:
at least one measuring device for measuring data relating to the physiological condition of said animal, wherein said data are compared to at least one threshold value when evaluating the physiological status of said animal,
a processor, and
indication means operated by said processor for indicating said physiological status of said animal.

In that way, nearby people can be warned by said indication means about the current physiological status of the animal, which makes the animal more trustable. The animal can e.g. be a dog, cat, or other kinds of pets, or zoo-animals, e.g. lion, tiger, etc. Further, in cases where the physiological status of the animal is unstable, dangerous actions performed by the animal can be prevented, e.g. by avoiding the animal. More particu-larly, the owner of the animal is then aware of the current status and can in that way react accordingly.

In one embodiment, said device further comprises a stimuli unit operated by said processor for providing painful sanctions to the animal if said measured physiological data exceed said threshold values. In another embodiment, said stimuli unit is implanted into said animal. In that way, the animal can be warned and/or calmed down very effectively, and all dangerous actions performed by the animal can be prevented before the animal causes injuries, or even kills another animals or a human being.

In an embodiment, said stimuli unit is further operated by the owner or the trainer of the animal. In that way, the owner might be able to prevent such stimuli, although the physiological data exceed one or more threshold values. This could be the case where the animal, e.g. a dog, is hunting a wild animal, which is allowed.

In an embodiment, said stimuli unit is adapted to increase the level of painful sanction if the animal does not respond to said painful sanction. As an example, the next level of painful sanction may be applied, if either the next, higher threshold is reached or after a predefined time if the measured physiological data are not again below the first threshold. In that way, if the animal does not respond to the first stimuli, the stimuli can be increased until it affects the animal and calms it down. The magnitude of said painful sanction may also be adapted to each individual animal, so that the device monitors how each individual animal reacts (can be two dogs of the same race) and based thereon adjusts the level of sanction. Before applying said painful sanction, the animal is preferably warned, and in that way the animal is given an opportunity to adjust its behavior.

In an embodiment, said stimuli unit comprises at least one unit from the group consisting of:
an acoustic unit,
a mechanical stimuli unit like pressure or vibration,
an electric stimuli unit,
a thermal stimuli unit, and
a narcotic drug delivery unit.

The acoustic unit can e.g. be adapted to provide an acoustic signal. This can be performed by the owner of the animal by speaking directly e.g. through his mobile phone, wherein the frequency of the acoustic signal might be shifted artificially to higher frequency, e.g. 20 kHz or more. The mechanical stimuli may e.g. comprise automatically contracting the collar worn by the animal. The electrical stimuli unit (which could also be an implantable device, known as neuro stimulators) is preferably adapted to provide electrical pulses, or electrical shocks. The thermal stimuli unit can either comprise hot or cold on the skin or inside the body using an implantable device. The narcotic drug delivery unit could be adapted to provide an injection via a trans-dermal drug system (ink jet like device or micro-needle arrays) or by making use of an advanced implantable device. Said different stimuli units may be used when the level of painful sanction must be increased, as in the previously mentioned embodiment. As an example, the acoustic stimuli could be used as the first step in warning the animal, subsequently the volume and/or the frequency could be increased, and the injection stimuli could be used as the last step. Furthermore, said stimuli units may be adapted to different animals, depending on whether the animal is a lion, or a cat.

In an embodiment, said device further comprises memory having stored therein said threshold values. In that way, said processor can further be adapted to evaluate said physiological status of said animal so that said evaluation of the physiological state of the animal is performed completely at said device side.

In one embodiment, said device further comprises a transmitter for transmitting said physiological data to a user device, said transmitter being further adapted to transmit warning data to said owner/trainer when said physiological data are outside of said threshold values. In another embodiment, said device further comprises a receiver for receiving data from said user device. Thereby, said evaluation of the physiological state of the animal can be performed at the user side by a user device, e.g. a mobile phone, PDA or any kind of device comprising a processor, wherein the transmitter transmits the output values from the measuring devices to said user device and the receiver can receive the result of the processing from the user device. This further enables the user (the trainer, owner, or the person responsible to the animal) to prevent a sanction by sending a canceling message to said device, although one or more of said physiological data have exceeded one or more of said threshold values.

In an embodiment, said at least one measuring device for measuring physiological data of said animal comprises at least one measuring device from a group consisting of:
an electrocardiogram (ECG),
an electroencephalogram (EEG),
an electromyogram (EMG),
a GSR (galvanic skin resistance) sensor,
a temperature sensor,
an implantable or transdermal blood sensor,
an implantable nerve sensor,
a glucose monitoring device, and
an implantable or transdermal glucose monitoring device.

Accordingly, said threshold values may define maximum values relating to e.g. maximum heart activity level or maximum number of electrical impulses generated per unit time when using an ECG measuring device, a maximum current set up by brain actions when using an EEG measuring device, a maximum electrical current generated in a muscle during its contraction when using an EMG measuring device, etc. Said implantable nerve sensor can either be electrically or chemically driven.

In an embodiment, said indication means comprises at least one indication means from a group consisting of:
a light source,
a light modulation device,
a display device, and
an acoustic system.

In that way, people can be warned visually and/or acoustically about the physiological status of the animal. If, as an example, the physiological status is ok, a green light illuminates, whereas a red light illuminates if the status is not ok, or if the device is de-activated and the animal is not trustworthy. The acoustic system could be implemented in addition to said light source for providing an acoustic warning signal. Additional means can also be comprised for indicating that the device has been disabled or is non-functional.

According to another aspect, the present invention relates to a method of indicating the physiological status of an animal by using a device to be attached to or to be worn by said animal, said device comprising at least one measuring device and an indication means, said method comprising the steps of:
measuring data relating to the physiological condition of said animal using said at least one measuring device, wherein said data are compared to at least one threshold value when evaluating the physiological status of said animal, and based on said evaluation
indicating said physiological status of said animal using said indication means.

According to yet another aspect, the present invention relates to a user device adapted to operate a device to be attached to or to be worn by an animal, wherein said device operated by said user device is used for indicating the physiological status of the animal, said user device comprising:
a receiver for receiving data from said device relating to the physiological condition of said animal,
a memory for storing at least one threshold value,
a processor for comparing said received data to said at least one threshold value when evaluating the physiological status of said animal, and
a transmitter for transmitting the result of said evaluation to said device.

According to still another aspect, the present invention relates to a method of operating a device to be attached to or to be worn by an animal using a user device, wherein said device is adapted to indicate the physiological status of the animal, said method comprising the steps of:
receiving data from said device relating to the physiological condition of said animal,
comparing said received data to at least one pre-stored threshold value when evaluating the physiological status of said animal, and
transmitting the result of said evaluation to said device.

The present invention further relates to a computer-readable medium having stored therein instructions for causing a processing unit to execute said methods.

These and other aspects of the invention will be apparent from and elucidated with reference to the embodiment(s) described hereinafter.

### BRIEF DESCRIPTION OF THE DRAWINGS

In the following preferred embodiments of the invention will be described referring to the figures, where:

FIG. 1 illustrates the principle of the present invention, namely to inform a person about the physiological status of an animal,

FIG. 2 shows a device according to the present invention to be attached to or to be worn by an animal for indicating the physiological status of the animal,

FIG. 3 illustrates a method according to the present invention of indicating the physiological status of the animal, and

FIG. 4 shows a user device according to the present invention for operating a device to be attached to or to be worn by an animal.

### DESCRIPTION OF PREFERRED EMBODIMENTS

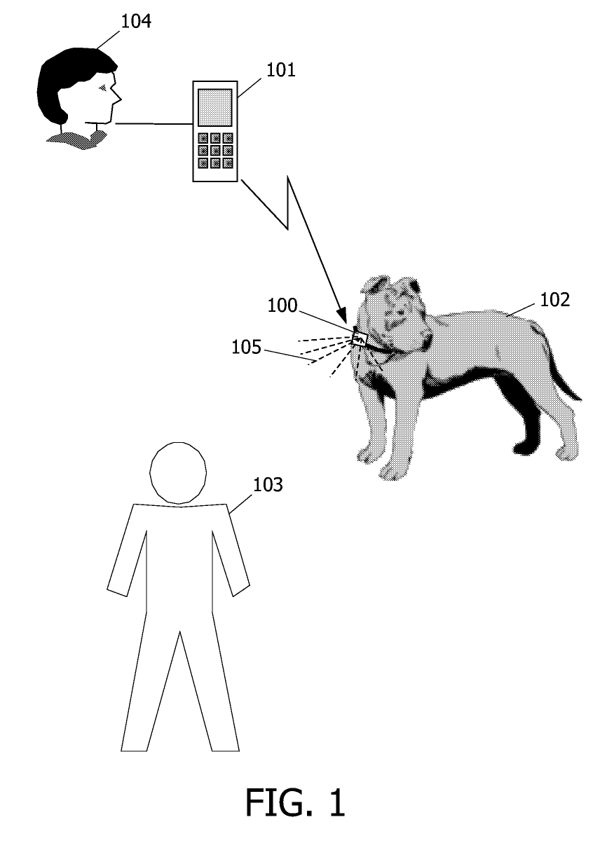

FIG. 1 illustrates the principle of the present invention, namely to inform a person about the physiological status of an animal and in that way make the animals more trustable for other people 103. In the following, it will be assumed that the animal is a dog 102. The device 100 shown here is attached or embedded to the collar of the dog 102 and used for regularly or continuously measuring data relating to the physiological condition of the dog 102 through one or more measuring devices. The physiological data can e.g. be the heart activity of the dog, GSR, electrical activity in the brain of the dog, evaluation of the nerve and muscle function, muscles tension, glucose measurement or data indicating the stress of the dog, e.g. oxidative stress. These data are regularly compared to pre-defined threshold values when evaluating the physiological status of said dog 102. Preferably combinations of several measured parameters are analyzed making the system more robust against measurement artifacts. Based thereon, the physiological status of the dog 102 is indicated to the person 103, e.g. children, passer-by, cyclists etc. This could be done via a visible light 105, or a pulsed light. As an example, a green light might indicate an “OK” physiological status of the animal, i.e. the dog 102 is trustable, whereas a red light might indicate a “NOT OK” physiological status of the dog 102, i.e. a non-trustable state if the data exceed one or more of said threshold values. There can of course be several intermediate states, which can be indicated to the people. An additional signal may be used for warning the people that the device has been deactivated.

In a preferred embodiment, if the physiological status of the dog 102 is “NOT OK”, the people 103 may additionally be warned by an acoustic noise, e.g. a warning voice telling the people to keep away from the dog 102.

In an embodiment, a stimuli unit is additionally provided, e.g. integrated in said collar, for calming the dog if the one or more of the measured data exceed one or more threshold values. This could e.g. be done by using a high frequency sound, which alerts the dog 102, but which does not disturb people 103, or by using mechanical stimuli like contracting the collar, or by using a drug injection which could be injected transdermally or through an implantable device.

In an embodiment, said device 100 is further adapted to send a wirelessly transmitted warning signal when the measured data exceed one or more threshold values. This might as an example be the case if the dog 102 has escaped, or is too far away from the owner 104, i.e. the owner has no control over the dog 102. In such situations the device could be adapted to send an SMS warning message to the owner of the dog 102, or to a police station. In a preferred embodiment, the owner has the possibility of speaking directly to the animal e.g. through his mobile phone.

In an embodiment, the device 100 is further adapted to receive instructions from the owner/trainer 104 of the animal. These instructions can e.g. comprise preventing a painful sanction if the owner 104 feels that the physiological status of the dog 102 is normal, although the physiological data indicate otherwise. This could be the case where the dog is hunting a wild animal, which might be allowed.

In one embodiment, the step of evaluating the physiological status of the dog is performed at the device 100 side, wherein, based on the evaluation, the physiological status of the dog 102 is indicated (e.g. visually in a way as discussed previously). In this manner, the painful sanction can also be locally activated, resulting in a device 100 which can operate independently of the owner 104.

In another embodiment, said evaluation is performed externally, e.g. at the user 104 side, wherein the physiological data are regularly, or continuously, transmitted to the user device 101 operated by the user 104 where they are compared to said threshold values.

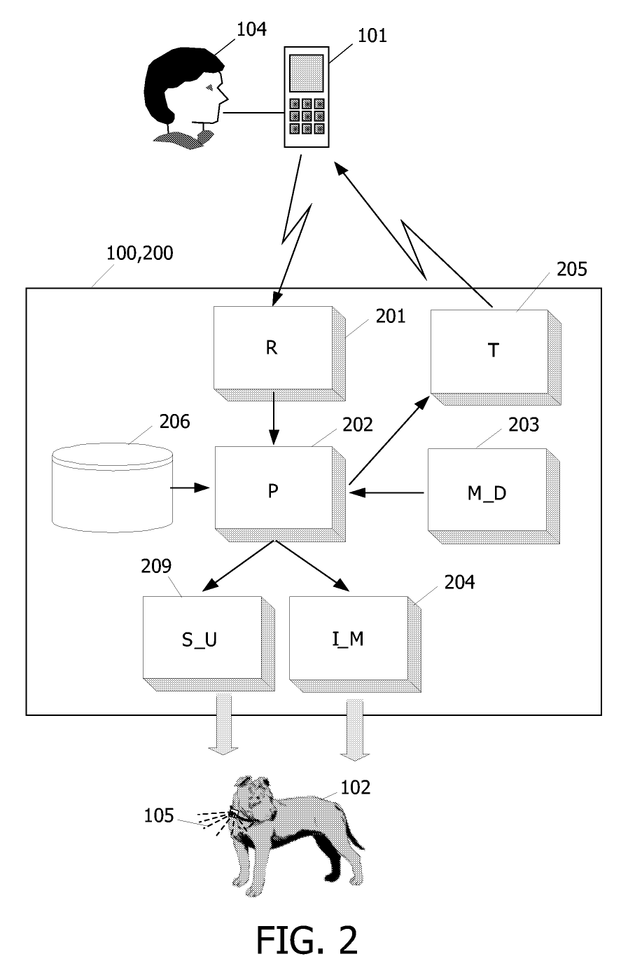

FIG. 2 shows a device 100, 200 according to the present invention to be attached to or to be worn by an animal 102 for indicating the physiological status of the animal 102. The device 100, 200 comprises one or more measuring devices (M_D) 203 for measuring data relating to the physiological condition of the animal 102, wherein the physiological data resulting from the measuring are regularly, or continuously, compared to pre-defined threshold values. The device 100, 200 further comprises a processor (P) 202, and indication means (I_M) 204 for indicating the current physiological status of the animal 102 based on the result obtained by comparing the physiological data to the threshold values.

The one or more measuring devices (M_D) 203 can comprise one or more measuring devices, such as an electrocardiogram (ECG), an electroencephalogram (EEG), an electromyogram (EMG), a temperature sensor, a blood sensor, a nerve sensor, a glucose monitoring device, devices which analyze chemically by electrophoretical means by extracting body fluids through the skin of the animal. Also, devices that measure the stress of the animal or implantable measurement devices can be used when detecting the physiological status of the animal.

The indication means (I_M) 204 can comprise a light source, a light modulating device, a display device or an acoustic system for indicating the current status of the animal 102. The indication could, as mentioned previously, comprise using a green or a red light, or comprising using an oral warning, or using a pulsed light. Additional means (not shown) may be provided for indicating that e.g. the system in not working properly (low battery, broken contacts etc.) or has been disabled, or been de-activated, so that the animal is not trustworthy.

In an embodiment, said device 100, 200 further comprises a stimuli unit (S_U) 209 for providing painful sanctions to the animal 102 if the measured physiological data exceed one or more threshold values. The stimuli unit (S_U) 209 can comprise one or more units from the group consisting of: an impulse generator for generating electrical pulses, an acoustic system for generating high frequent sound, e.g. 20 kHz or higher, a mechanical stimuli for e.g. contracting the collar the animal wears, heat shocks, a drug injection mechanism or advanced implantable devices.

In an embodiment, the stimuli unit (S_U) 209 is adapted to increase the level of painful sanctions using one or more of said stimuli unit (S_U) 209 if the animal does not respond to said painful sanctions. As an example, in a first step a non-painful stimuli such as light visible to the animal or a non-hurting sound is applied to the animal, allowing a learning effect. After some times the animal knows that, after that warning signal, there will be some painful sanctions, which it will try to avoid. This could improve acceptance of a device according to the invention amongst the owners of pets.

In an embodiment, said device 100, 200 further comprises a memory 206 having stored therein said threshold values. In this embodiment, said processor (P) 202 is further adapted to process the output from said one or more measuring device (M_D) 203 into said physiological data and perform the step of evaluating the physiological status of the animal by comparing said data with the threshold values stored in said memory 206. Said processor (P) is also adapted to operate the indication means (I_M) 204 based on the result of said evaluation.

In an embodiment, said step of comparing the physiological data to the threshold values is performed at the user 104 side by a processor comprised in said user device 101 operated by the user 104. This user device 101 can be a hand held device such as a mobile phone, PDA or any kind of device comprising a processor, wherein additionally the threshold values are preferably pre-stored at said device 101. In this embodiment, a transmitter (T) 205 and a receiver (R) 201 are further comprised in the device 100, 200 for interacting with said user device 101 for transmitting the output values from the measuring devices (M_D) 203 to said user device 101, and for receiving the result of the processing from the user device 101. The received result is then used for indicating said current physiological status of said animal. As an example, if the result is that the physiological data are within the threshold values, the processor (P) 202 operates the indication means (I_M) 204 by e.g. illuminating a green light. If, however, the result of the processing is that the physiological of the animal 102 is not ok, the processor (P) 202 might activate the stimuli unit (S_U) 209 (depending on whether the user 104 decides something else) and/or indicate the current unstable physiological status of the dog 102 by illuminating a red light.

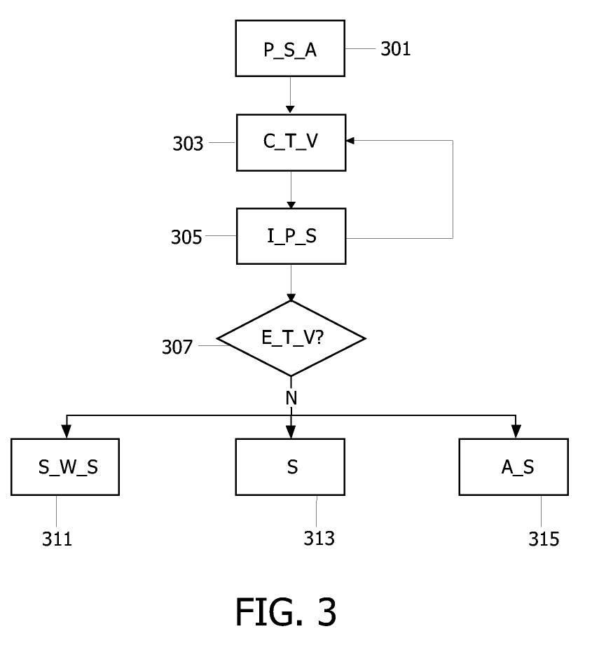

FIG. 3 illustrates a method according to the present invention of indicating the physiological status of the animal. The physiological state of the animal is initially measured (P_S_A) 301 using one or more measuring devices for measuring data relating to the physiological condition of said animal. The data are compared to one or more pre-defined threshold values (C_T_H) 303, when evaluating the physiological status of said animal. This can be done either in the device 100 attached to or worn by the animal, or at an external user device 101 side. The result of the evaluation is then used for indicating the physiological status of the animal (I_P_S) 305. This can be done in a way as mentioned previously in the description, e.g. by illuminating a green light or a red light.

In an embodiment, if the result of the evaluation of the physiological status of said animal shows that one or more physiological data exceed the threshold values (E_T_V?) 307, a warning signal (S_W_S) 311 may be sent to the owner of the animal, and/or a stimuli may be applied (S) 313 for warning or calming the animal, and/or an acoustic signal can be used (A_S) 315 for warning people nearby the animal not to approach it.

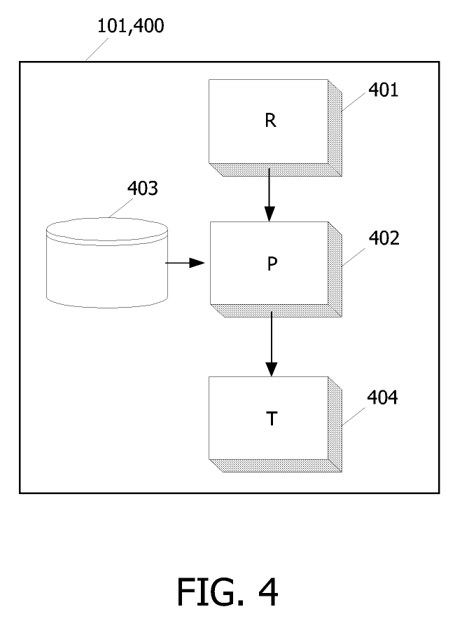

FIG. 4 shows a user device 101, 400 according to the present invention for operating a device 100, 200 attached to or worn by an animal, e.g. a dog 102. The user device 101, 400 comprises a receiver (R) 401 for receiving data from said device 100, 200, wherein said data relate to the physiological condition of said animal 102 and a memory 403 for storing at least one threshold value. The user device 101, 400 further comprises a processor (P) 402 for comparing the received data to the at least one threshold value when evaluating the physiological status of said animal 102, and a transmitter (T) 404 for transmitting the evaluated physiological status of said animal 102 to said device 100, 200.

In a preferred embodiment, the user device 101, 400 is a remote control, which remotely operates the device 100, 200, e.g. a mobile phone, or any kind of hand-held device comprising a processor and a memory.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A device (100, 200) to be attached to or to be worn by an animal (102) for indicating the physiological status of the animal (102), comprising:
at least one measuring device (203) for measuring data relating to the physiological condition of said animal (102), wherein said data are compared to at least one threshold value when evaluating the physiological status of said animal (102),
a processor (202), and
indication means (204) operated by said processor (202) for indicating said physiological status of said animal (102).

2. A device according to claim 1, further comprising a stimuli unit (209) operated by said processor (202) for providing painful sanctions to said animal (102) if said measured physiological data exceed said threshold values.

3. A device according to claim 2, wherein said stimuli unit (209) is implanted into said animal (102).

4. A device according to claim 2, wherein said stimuli unit (209) is further adapted to be operated by the owner (104) or the trainer of the animal (102).

5. A device according to claim 2, wherein said stimuli unit (209) is adapted to increase the level of painful sanctions if the animal (102) does not respond to said painful sanctions.

6. A device according to claim 2, wherein said stimuli unit (209) comprises at least one unit from the group consisting of:
an acoustic unit,
a mechanical stimuli unit like pressure or vibration,
an electric stimuli unit,
a thermal stimuli unit, and
a narcotic drug delivery unit.

7. A device according to claim 1, further comprising memory (206) having stored therein said threshold values.

8. A device according to claim 1, further comprising a transmitter (205) for transmitting said physiological data to a user device (101, 400), said transmitter (205) being further adapted to transmit warning data to said owner/trainer (104) when said physiological data are outside of said threshold values.

9. A device according to claim 1, further comprising a receiver (201) for receiving data from said user device (101, 400).

10. A device according to claim 1, wherein said at least one measuring devices (203) for measuring physiological data of said animal comprise at least one measuring device from a group consisting of:
an electrocardiogram (ECG),
an electroencephalogram (EEG),
an electromyogram (EMG),
a GSR-sensor,
a temperature sensor,
an implantable or transdermal blood sensor,
an implantable nerve sensor, and
an implantable or transdermal glucose monitoring device.

11. A device according to claim 1, wherein said indication means (204) comprises at least one indication means from a group consisting of:
a light source,
a light modulation device,
a display device, and
an acoustic system.

12. A method of indicating the physiological status of an animal (102) by using a device (100, 200) to be attached to or to be worn by said animal (102), said device comprising at least one measuring device (203) and an indication means (204), said method comprising the steps of:
measuring data relating to the physiological condition of said animal (102) using said at least one measuring device (203), wherein said data are compared to at least one threshold value when evaluating the physiological status of said animal (102), and based on said evaluation
indicating said physiological status of said animal (102) using said indication means.

13. A computer-readable medium having stored therein instructions for causing a processing unit to execute a method according to claim 12.

14. A user device (101, 400) adapted to operate a device (100, 200) to be attached to or to be worn by an animal (102), wherein said device (100, 200) operated by said user device (101, 400) is used for indicating the physiological status of the animal (102), said user device comprising:
a receiver (401) for receiving data from said device (100, 200) relating to the physiological condition of said animal (102),
a memory (403) for storing at least one threshold value,
a processor (402) for comparing said received data to said at least one threshold value when evaluating the physiological status of said animal (102), and
a transmitter (404) for transmitting the result of said evaluation to said device (100, 200).

15. A method of operating a device (100, 200) to be attached to or to be worn by an animal (102) using a user device (101, 400), wherein said device (100, 200) is adapted to indicate the physiological status of the animal (102), said method comprising the steps of:
receiving data from said device (100, 200) relating to the physiological condition of said animal (102),
comparing said received data to at least one pre-stored threshold value when evaluating the physiological status of said animal (102), and
transmitting the result of said evaluation to said device (100, 200).

16. A computer-readable medium having stored therein instructions for causing a processing unit to execute a method according to claim 15.
